(19) United States
(12) Patent Application Publication
(10) Pub. No.: US 2025/0303335 A1
(43) Pub. Date: Oct. 2, 2025

(54) HONEYCOMB STRUCTURE

(71) Applicant: NGK INSULATORS, LTD., Nagoya-City (JP)

(72) Inventor: Hiroaki HAYASHI, Nagoya-Shi (JP)

(73) Assignee: NGK INSULATORS, LTD., Nagoya-City (JP)

(21) Appl. No.: 19/070,898

(22) Filed: Mar. 5, 2025

(30) Foreign Application Priority Data
Mar. 29, 2024 (JP) 2024-058116

(51) Int. Cl. B01D 46/24

(52) U.S. Cl. CPC B01D 46/2462; B01D 46/2444; B01D 46/24491; B01D 46/2482

(57) ABSTRACT

A honeycomb structure includes an outer peripheral side wall; a plurality of first cells having an opening on the first end surface and having a sealing portion on the second end surface; and a plurality of second cells having the sealing portion on the first end surface and having the opening on the second end surface, wherein the first cells and the second cells are arranged adjacent to each other with a partition wall interposed therebetween; wherein the sealing portion is composed of a ceramic containing MgO:9.0 to 13.4% by mass, Al₂O₃: 29.0 to 35.5% by mass, and SiO₂: 50.0 to 58.0% by mass, and wherein an arithmetic average height Sa of the sealing portions on the first end surface and the second end surface is 18.0 μm or less, respectively.

### CROSS REFERENCE TO RELATED APPLICATIONS

The present invention claims the benefit of priority to Japanese Patent Application No. 2024-58116 filed on Mar. 29, 2024 with the Japanese Patent Office, the entire contents of which are incorporated herein by reference in its entirety.

### FIELD OF THE INVENTION

The present invention relates to a honeycomb structure.

### BACKGROUND OF THE INVENTION

Exhaust gas emitted from internal combustion engines such as diesel engines contains a large amount of particulate matter (particulate matter) whose main component is carbon and which causes environmental pollution. For this reason, exhaust systems of diesel engines and the like are generally equipped with a filter (Diesel Particulate Filter: DPF) to collect particulates. Further, in recent years, particulate matter emitted from gasoline engines has also become a problem, and gasoline engines are now being equipped with filters (Gasoline Particulate Filter: GPF).

As a filter, there is known a wall-flow type honeycomb structure, which has an outer peripheral side wall; a plurality of first cells arranged on the inner peripheral side of the outer peripheral side wall, extending from a first end surface to a second end surface, having an opening on the first end surface and having a sealing portion on the second end surface; and a plurality of second cells arranged on the inner peripheral side of the outer peripheral side wall, extending from the first end surface to the second end surface, having the sealing portion on the first end surface and having the opening on the second end surface, wherein the first cells and the second cells are arranged adjacent to each other with a partition wall interposed therebetween.

In a wall-flow type honeycomb structure, the sealing portion serves to prevent trapped particulate matter from leaking out of the filter (erosion). For this reason, it is important in order to ensure the filter performance that the sealing portions be formed at predetermined positions to a predetermined depth without peeling off.

Patent Literature 1 describes a honeycomb filter that has an object of providing a honeycomb filter in which cracks do not occur in the sealing portions and the substrate, and in which the sealing portions do not peel off or fall off from the substrate, and the honeycomb filter is characterized in that the sealing material is made of pulverized ceramic of the same material as the ceramic substrate.

In Patent Literature 2, an object is to obtain a ceramic honeycomb filter having excellent thermal shock resistance, and there is described a honeycomb filter made of a material having cordierite as a main crystal, in which at least a part of the sealing portion is composed of an amorphous oxide matrix formed from ceramic particles and colloidal oxides present between the ceramic particles.

In Patent Literature 3, an object is to provide a honeycomb structure that can suppress defects such as peeling of sealing portions during canning and can effectively prevent erosion, and there is described a honeycomb structure in which the average porosity of the sealing portion is controlled to 4% or less is described.

### PRIOR ART

### Patent Literature

[Patent Literature 1] Japanese Patent Application Publication No. 2002-136817
[Patent Literature 2] Japanese Patent Application Publication No. 2005-125318
[Patent Literature 3] Japanese Patent Application Publication No. 2021-159868

### SUMMARY OF THE INVENTION

When forming sealing portions, a masking film is temporarily attached to the end surface of the honeycomb structure in order to distinguish the cells in which sealing portions are to be formed from the other cells. The film is finally peeled off, but during this process, peeling of the sealing portions occurs locally, which requires a considerable amount of time to repair and may even result in a defective product. The conventional techniques do not provide sufficient measures against peeling of the sealing portions when the film is peeled off, and there is still room for improvement.

The present invention has been made in consideration of the above circumstances, and an object in one embodiment of the present invention is to provide a honeycomb structure that can suppress peeling of the sealing portions when the film is peeled off.

The present inventor has conducted extensive research to solve the above problems and have found that controlling the composition and surface roughness of the sealing portion is important in solving the above problems. The present invention has been completed based on this finding and is exemplified as below.

### [Aspect 1]

A honeycomb structure, comprising an outer peripheral side wall; a plurality of first cells arranged on an inner peripheral side of the outer peripheral side wall, extending from a first end surface to a second end surface, having an opening on the first end surface and having a sealing portion on the second end surface; and a plurality of second cells arranged on the inner peripheral side of the outer peripheral side wall, extending from the first end surface to the second end surface, having the sealing portion on the first end surface and having the opening on the second end surface, wherein the first cells and the second cells are arranged adjacent to each other with a partition wall interposed therebetween;

wherein the sealing portion is composed of a ceramic containing MgO: 9.0 to 13.4% by mass, Al₂O₃: 29.0 to 35.5% by mass, and SiO₂: 50.0 to 58.0% by mass, and wherein an arithmetic average height Sa of the sealing portion on the first end surface and the second end surface is 18.0 μm or less, respectively.

### [Aspect 2]

The honeycomb structure according to aspect 1, wherein the sealing portion is composed of a ceramic containing MgO: 9.0 to 12.0% by mass, Al₂O₃: 29.8 to 32.0% by mass, and SiO₂: 54.0 to 57.2% by mass.

### [Aspect 3]

The honeycomb structure according to aspect 1 or 2, wherein the arithmetic mean height Sa of the sealing portion on the first end surface and the second end surface is 5.0 to 17.5 μm, respectively.

### [Aspect 4]

The honeycomb structure according to aspect 1 or 2, wherein the arithmetic mean height Sa of the sealing portion on the first end surface and the second end surface is 5.0 to 12.0 μm, respectively.

### [Aspect 5]

The honeycomb structure according to any one of aspects 1 to 4, wherein the sealing portion is in an unfired state.

### [Aspect 6]

The honeycomb structure according to aspect 5, wherein the ceramic composing the sealing portion comprises cordierite particles, and colloidal silica bonding the cordierite particles together.

### [Aspect 7]

The honeycomb structure according to any one of aspects 1 to 4, wherein the sealing portion is in a fired state.

### [Aspect 8]

The honeycomb structure according to aspect 7, wherein the ceramic composing the sealing portion is a fired body of cordierite.

### [Aspect 9]

The honeycomb structure according to any one of aspects 1 to 8, wherein a median diameter of the ceramic composing the sealing portion is 5 to 25 μm.

### [Aspect 10]

The honeycomb structure according to any one of aspects 1 to 9, wherein an average porosity of the sealing portion on the first end surface and the second end surface is 30 to 70%, respectively.

### [Aspect 11]

The honeycomb structure according to any one of aspects 1 to 10, wherein the partition walls are composed of ceramic comprising cordierite as a main component.

### [Aspect 12]

The honeycomb structure according to any one of aspects 1 to 11, wherein an average depth of the sealing portion on the first end surface and the second end surface is 3 to 7 mm, respectively.

According to one embodiment of the present invention, there is provided a honeycomb structure capable of suppressing peeling of the sealing portions when a film is peeled off. By suppressing peeling of the sealing portions, it becomes possible to stably exhibit the desired performance required for the sealing portions, such as preventing erosion of trapped particulate matter. Therefore, the honeycomb structure can be suitably used as a honeycomb filter or the like having excellent quality stability.

### BRIEF DESCRIPTION OF THE DRAWINGS

FIG. 1 is a perspective view showing a wall-flow type honeycomb structure.

FIG. 2 is a schematic cross-sectional view of a wall-flow type honeycomb structure observed at a cross section parallel to the direction in which the cells extend.

FIG. 3 is a schematic partial enlarged view of a partition wall of a honeycomb structure observed at a cross section orthogonal to the direction in which the cells extend.

FIG. 4 is a schematic partial cross-sectional view for explaining a method for measuring the depth of sealing portions.

FIG. 5 is an explanatory diagram showing a schematic example of a method for forming sealing portions using a squeegee method.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### (1. Honeycomb Structure)

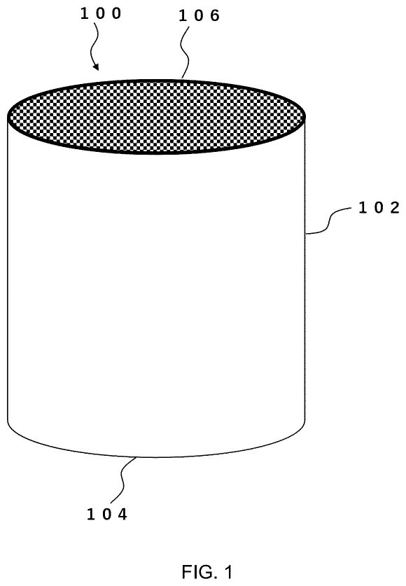

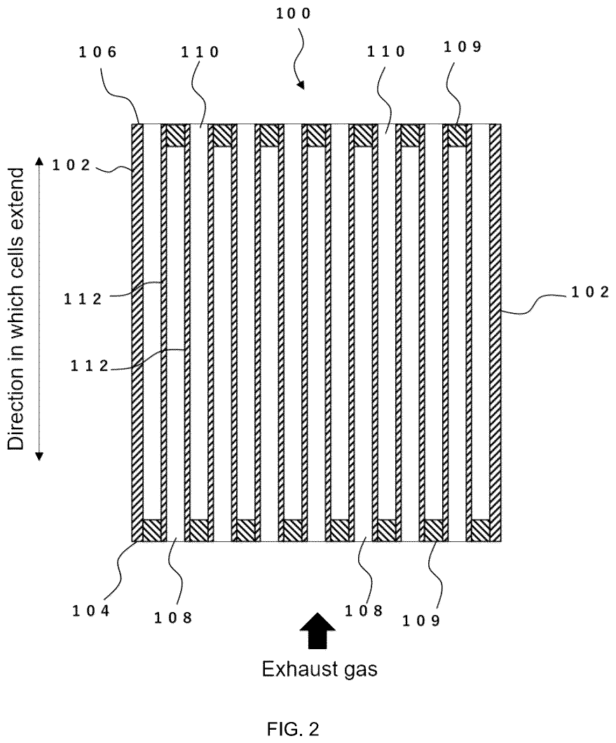

FIGS. 1 and 2 are a schematic perspective view and a cross-sectional view, respectively, of a pillar-shaped honeycomb structure 100 that can be used as a wall-flow type exhaust gas filter and/or a catalyst carrier for automobiles. The honeycomb structure 100 comprises: an outer peripheral side wall 102; a plurality of first cells 108 arranged on the inner peripheral side of the outer peripheral side wall 102, extending from an first end surface 104 to a second end surface 106 in parallel, having an opening at the first end surface 104, and having a sealing portion 109 at the second end surface 106; and a plurality of second cells 110 arranged on the inner peripheral side of the outer peripheral side wall 102, extending from the first end surface 104 to the second end surface 106 in parallel, having the sealing portion 109 at the first end surface, and having an opening at the second end surface 106, wherein the first cells 108 and the second cells 110 are arranged adjacent to each other with a partition wall 112 interposed therebetween.

For example, when exhaust gas containing particulate matter such as soot is supplied to the first end surface 104 on the upstream side of the honeycomb structure 100, the exhaust gas is introduced into the first cells 108 and travels downstream within the first cells 108. Since the first cell 108 is sealed on the second end surface 106 which is on the downstream side, the exhaust gas passes through the porous partition walls 112 that separates the first cells 108 and the second cells 110 and flows into the second cells 110. The particulate matter cannot pass through the partition walls 112 and is therefore collected and deposited in the first cells 108. After the particulate matter has been removed, the clean exhaust gas that has flowed into the second cells 110 advances downstream within the second cells 110 and flows out from the second end surface 106 which is on the downstream side.

The shape of the end surface of the honeycomb structure 100 is not limited, and may be, for example, a round shape such as a circle, an ellipse, a racetrack shape or an oval shape, a polygonal shape such as a triangle or a quadrangle, or other irregular shape. The honeycomb structure 100 can have a pillar-like outer shape. The honeycomb structure 100 shown in the figure has a circular shape on the end surfaces and is cylindrical as a whole.

There is no particular limitation on the height of the honeycomb structure (the length from the first end surface to the second end surface), and it may be appropriately set depending on the application and required performance. The height of the honeycomb structure may be, for example, 40 to 450 mm. There is no particular limitation on the relationship between the height of the honeycomb structure and the maximum diameter of each end surface (the maximum length of the diameters passing through the center of gravity of each end surface of the honeycomb structure). Therefore, the height of the honeycomb structure may be longer than the maximum diameter of each end surface, or the height of the honeycomb structure may be shorter than the maximum diameter of each end surface.

There are no limitations on the shape of the cell opening in a cross section perpendicular to the direction in which the cells extend, but it is preferably a quadrangle, a hexagon, an octagon, or a combination of these. Of these, square and hexagonal shapes are preferable. By using such cell shapes, pressure loss when a fluid is made to flow through the honeycomb structure is reduced, and purification performance is improved.

The cell density (the number of cells per unit cross-sectional area) is not particularly limited, and can be, for example, 6 to 2000 cells/inch² (0.9 to 311 cells/cm²), more preferably 50 to 1000 cells/inch² (7.8 to 155 cells/cm²), and particularly preferably 100 to 600 cells/inch² (15.5 to 92.0 cells/cm²). Here, the cell density is calculated by dividing the total number of cells (including the sealed cells) by the area of one end surface of the honeycomb structure excluding the outer peripheral side wall.

The average thickness of the partition walls is preferably 150 μm or more, more preferably 170 μm or more, and even more preferably 190 μm or more, from the viewpoints of increasing the strength of the honeycomb structure and the collection efficiency in the case of filter applications. In addition, from the viewpoint of suppressing pressure loss, the average thickness of the partition walls is preferably 260 μm or less, more preferably 240 μm or less, and even more preferably 220 μm or less. Therefore, the average thickness of the partition walls is, for example, preferably from 150 to 260 μm, more preferably from 170 to 240 μm, and further preferably from 190 to 220 μm.

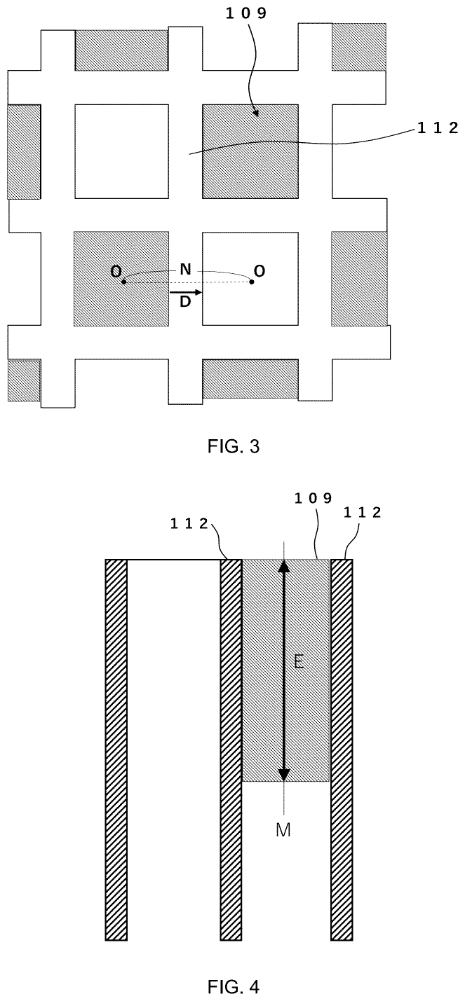

FIG. 3 shows a schematic partial enlarged view of the partition walls 112 of the honeycomb structure 100 observed in a cross section orthogonal to the direction in which the cells extend. The thickness of the partition wall refers to a crossing length of a line segment N that crosses the partition wall when the centers of gravity O of adjacent cells are connected by this line segment N in a cross-section orthogonal to the direction in which the cells extend (the height direction of the honeycomb structure). The thickness direction D of the partition walls indicates a direction parallel to the line segment N. The average thickness of the partition walls indicates an average value of the thicknesses of all the partition walls.

The partition walls may be porous. The average porosity of the partition walls may be appropriately adjusted depending on the application, but from the viewpoint of keeping the pressure loss of the fluid low, it is preferably 40% or more, more preferably 50% or more, and even more preferably 60% or more. In addition, from the viewpoint of ensuring the strength of the honeycomb structure, the average porosity of the partition walls is preferably 80% or less, more preferably 75% or less, and even more preferably 70% or less. Therefore, the average porosity of the partition walls is, for example, preferably from 40 to 80%, more preferably from 50 to 75%, and further preferably from 60 to 70%.

The porosity of the partition walls is measured by mercury intrusion porosimetry in accordance with JIS R1655: 2003. Twenty test pieces of the partition walls are taken evenly from the locations including the center and outer periphery of the honeycomb structure, and the porosity of each test piece is measured, and the average value is taken as the average porosity.

The material composing the partition walls and the outer peripheral side wall is not particularly limited, but is preferably ceramic from the viewpoint of strength and heat resistance. Ceramic preferably contains, for example, one or more selected from the group consisting of cordierite, mullite, zircon, aluminum titanate, silicon carbide, silicon-silicon carbide composite material, silicon nitride, zirconia, spinel, indialite, sapphirine, corundum, and titania.

Further, for these ceramics, one type may be contained alone, or two or more types may be contained in combination. The partition walls and the outer peripheral side wall are preferably formed from a material containing these ceramics in a total amount of 50% by mass or more, and more preferably 80% by mass or more.

In a preferred embodiment, each of the outer peripheral side wall, the partition walls and the sealing portions of the honeycomb structure comprises cordierite as a main component. This means that the total mass ratio of cordierite (2MgO·2Al₂O₃·5SiO₂) is 50% by mass or more with respect to 100% by mass of the materials composing the outer peripheral side wall, the partition walls and the sealing portions. The mass ratio of cordierite with respect to 100% by mass of the materials composing each of the outer peripheral side wall, the partition walls and the sealing portions is preferably 70% by mass or more, and more preferably 80% by mass or more.

The cordierite content can be measured by X-ray diffraction. Specifically, an X-ray diffraction apparatus using Cu Kα radiation (for example, X′pert PRO apparatus manufactured by Malvern Panalytical Ltd.) is used to perform X-ray analysis measurement in the range of 20=8 to 100° by X-ray diffraction on a sample of the outer peripheral side wall, the partition wall, or the sealing portion, and the cordierite crystal phase ratio is measured by analyzing using the Rietveld analysis program RIETAN, and this is regarded as the cordierite content.

Fine adjustment of the chemical composition of the sealing portions is advantageous in terms of suppressing peeling of the sealing portions when the film is peeled off. Specifically, the sealing portions are preferably composed of a ceramic containing 9.0 to 13.4% by mass of MgO, 29.0 to 35.5% by mass of Al₂O₃, and 50.0 to 58.0% by mass of SiO₂; more preferably composed of a ceramic containing 9.0 to 12.0% by mass of MgO, 29.8 to 32.0% by mass of Al₂O₃, and 54.0 to 57.2% by mass of SiO₂; and even more preferably composed of a ceramic containing 10.2 to 11.5% by mass of MgO, 30.5 to 32.0% by mass of Al₂O₃, and 54.5 to 56.2% by mass of SiO₂. This composition contains slightly less MgO and slightly more SiO₂ than ordinary cordierite, which has the effect of making the outer surface of the sealing portions easier to smooth. In addition, there is an effect that the mechanical strength of the sealing portion itself is improved.

It is desirable to prepare a measurement sample by cutting out the sealing portions from the honeycomb structure and measure the chemical composition of the measurement sample. However, if it is difficult to obtain 10.0 g of a measurement sample from the honeycomb structure, the measurement sample is prepared by the following method.

A sealing portion forming slurry the same as that used for preparing the sealing portions is prepared and poured into a stainless-steel mold having a diameter of 60 mm and a length of 15 mm. Then, the slurry is dried under the same conditions as those for the actual sealing portions and removed from the stainless-steel mold. Thereafter, if the actual sealing portions are fired, the dried slurry is fired under the same conditions. The obtained bulk body is pulverized to prepare a measurement sample. In the case where a measurement sample can be prepared by cutting out the sealing portions from a honeycomb structure, the measurement sample is prepared by pulverizing the cut sealing portions. The pulverization is performed under the conditions of a pestle rotation speed of 100/120 rpm, a mortar rotation speed of 6/7 rpm, and a pulverization time of 5 minutes.

10.0 g of a measurement sample is placed in an alloy crucible, 6.0 g of lithium tetraborate is added, and they are mixed with a platinum rod. The alloy crucible is placed in a vitrification device (for example, automatic bead sampler HA-HF16 manufactured by HERZOG Co., Ltd.) and vitrified under conditions of 1200° C. and 15 minutes (glass bead method). The glass beads of each sample are qualitatively analyzed by fluorescent X-ray analysis using Si Kα line, Al Kα line, and Mg Kα line determine the mass percentages of SiO₂, Al₂O₃, and MgO.

The smoothness of the outer surface of the sealing portion can be expressed using the arithmetic mean height Sa as an index. The arithmetic mean height Sa is a type of surface roughness parameter defined in ISO 25178, and represents the average of the absolute values of the height differences of each point with respect to the average surface of the surface. Specifically, the arithmetic mean height Sa of the sealing portions on the first end surface and the second end surface is preferably 18.0 μm or less, more preferably 17.5 μm or less, and even more preferably 12.0 μm or less. Although a lower limit is not particularly set for the arithmetic mean height Sa of the sealing portions, in consideration of the manufacturing cost, the arithmetic mean height Sa of the sealing portions on the first end surface and the second end surface is preferably 5.0 μm or more, more preferably 8.0 μm or more, and even more preferably 10.5 μm or more. Therefore, the arithmetic mean height Sa of the sealing portions on the first end surface and the second end surface is, for example, preferably 5.0 to 18.0 μm, more preferably 5.0 to 17.5 μm, even more preferably 8.0 to 17.5 μm, and still more preferably 5.0 to 12.0 μm.

As used herein, the arithmetic mean height Sa of the sealing portions on the first end surface and the second end surface is defined as an average value when measuring the arithmetic mean height Sa of the sealing portions at five locations without bias using a laser microscope.

For the sealing portion at one location, measurement can be performed under the following conditions.
Measurement equipment name: Shape analysis laser microscope (VK-X250/260 manufactured by Keyence Corporation) or a microscope with equivalent performance
Analysis software: Multi-file analysis application (VK-1HXM) or a software with equivalent performance
Objective lens magnification: 10 times
Sample size: 20 mm×20 mm×10 mm (depth direction of sealing portion)
Measurement mode: Surface shape
Measurement size per field of view: Standard (1024 pixels×768 pixels)
Measurement quality: High accuracy
Measurement time: 1 minute
Plane processing: A square area of 750 μm×750 μm is specified, and a process is performed to determine a plane (reference plane) to be used as the reference for measurement. The entire height data is rotated such that the set reference plane is horizontal, and offset in the height direction such that the reference plane height becomes 0.
Reference surface position: −3 μm (offset such that the position at a depth of 3 μm is 0 height.)
Ignore micro areas: Yes (number of pixels in micro areas: ≥6 pixels (surface irregularities less than 6 pixels are not recognized as holes.))

In one embodiment, the sealing portions may in a fired state. The ceramic composing the fired sealing portions can be provided as a fired body of cordierite, for example. The cordierite fired body can be obtained by firing a sealing portion forming slurry containing a cordierite-forming raw material.

In another embodiment, the sealing portions may be in an unfired state. In this case, the ceramic composing the sealing portions preferably contains, for example, cordierite particles and an inorganic binder that binds the cordierite particles together. As the inorganic binder, colloidal silica is suitable.

Regardless of whether the sealing portions are fired or not, it is preferable that the median diameter of the ceramic composing the sealing portions is small. This provides the effect of making the outer surface of the sealing portions easier to smooth. Specifically, the upper limit of the median diameter of the ceramic composing the sealing portions is preferably 25 μm or less, more preferably 20 μm or less, and further preferably 15 μm or less. In addition, from the viewpoint of suppressing a sink mark in the sealing portions, the lower limit of the ceramic composing the sealing portions is preferably 5 μm or more, more preferably 10 μm or more, and even more preferably 12 μm or more. Therefore, the median diameter of the ceramic composing the sealing portion is, for example, preferably 5 to 25 μm, more preferably 10 to 20 μm, and even more preferably 12 to 15 μm.

The median diameter of the ceramic composing the sealing portions is desirably measured on a measurement sample after cutting out the sealing portions from the honeycomb structure to prepare the measurement sample, but if it is difficult to prepare 2.0 g of the measurement sample from the honeycomb structure, the measurement sample is prepared by the following method.

A sealing portion forming slurry the same as that used for preparing the sealing portions is prepared and poured into a stainless-steel mold having a diameter of 60 mm and a length of 15 mm. Then, the slurry is dried under the same conditions as those for the actual sealing portions and removed from the stainless-steel mold. Thereafter, if the actual sealing portions are fired, the dried slurry is fired under the same conditions. The obtained bulk body is pulverized in an automatic mortar to prepare a measurement sample. In the case where a measurement sample can be prepared by cutting out the sealing portions from a honeycomb structure, the measurement sample is prepared by pulverizing the cut sealing portions. The pulverization is performed under the conditions of a pestle rotation speed of 100/120 rpm, a mortar rotation speed of 6/7 rpm, and a pulverization time of 5 minutes. 2.0 g of the measurement sample is placed in a laser diffraction/scattering type particle size distribution measurement device (in the Examples, Partica LA-960 manufactured by HORIBA, Ltd. was used), and the median diameter (D50) in the volume-based cumulative particle size distribution is measured by the laser diffraction/scattering method.

In one embodiment, the sealing portions of both the first end surface and the second end surface have an average depth of the sealing portions of 3 to 7 mm, preferably 4.2 to 6 mm. When the lower limit of the average depth of the sealing portions is 3 mm or more, the strength of the sealing portions can be ensured. The average depth of the sealing portions is preferably 4.2 mm or more. In addition, by setting the upper limit of the average depth of the sealing portions to 7 mm or less, it is possible to prevent the area of the partition walls that capture particulate matter in the cells from being reduced. The upper limit of the average depth of the sealing portions is preferably 6 mm or less. The depth of the sealing portions is measured at 20 points on each end surface without bias, and the average value is defined as the average depth of the sealing portions on each end surface.

As used herein, the depth of each sealing portion is measured by the following procedure. First, the sealing portion whose depth is to be measured is cut in half along a cutting plane parallel to the height direction (the direction in which the cells extend) of the honeycomb structure, and a pair of cross sections of the sealing portion is cut out. Either of the obtained cross sections of the sealing portion is entirely photographed with a laser microscope (for example, the shape analysis laser microscope VK X250/260 manufactured by Keyence Corporation) to generate a cross-sectional image of the sealing portion. For the cell in which a sealing portion is formed and which is observed in the cross-sectional image, the length in the direction in which the cell extends from the end on the outer surface side to the deepest position where the sealing portion 109 exists is measured along a central axis M (a straight line having an equal distance to a pair of opposing partition walls 112), which is defined as the depth E of the sealing portion (see FIG. 4).

In one embodiment, the average porosity of the sealing portions of the first end surface and the second end surface is 30% to 70%, preferably 35 to 60%, and more preferably 40 to 50%, respectively. Setting the lower limit of the average porosity of the sealing portions to 30% or more is advantageous in terms of reducing thermal stress and improving thermal shock resistance. The lower limit of the average porosity of the sealing portions is preferably 35% or more, and more preferably 40% or more. In addition, it is advantageous in terms of preventing erosion to set the upper limit of the average porosity of the sealing portions to 70% or less. The upper limit of the average porosity of the sealing portions is preferably 60% or less, and more preferably 50% or less.

Since it is difficult to directly measure the porosity of the sealing portions by sampling only the sealing portions, it can be measured by the mercury intrusion method specified in JIS 1655:2003 according to the following procedure.
Take a test piece of the partition wall portions where no sealing portions are formed, and measure the porosity P₁ of the test piece (porosity of the partition wall portions).
Take a test piece of the partition wall portions including the sealing portions, and measure the porosity P of the test piece (porosity of the partition wall portions+sealing portions).
For the test piece of the partition wall portions including the sealing portions, measure the volume V₁ including the pores of the partition wall portions.
For the test piece of the partition wall portions including the sealing portions, measure the volume V₂ including the pores of the sealing portions.

Assuming the porosity of the sealing portions is P₂, then P, P₁, P₂, V₁ and V₂ satisfy the relationship of Formula (1).

$$P = {P}_{1} \times {V}_{1} / ( {V}_{1} + {V}_{2} ) + {P}_{2} \times {V}_{2} / ( {V}_{1} + {V}_{2} ) \qquad ( 1 )$$

Therefore, P₂ can be determined by Formula (2).

$${P}_{2} = P \times ( {V}_{1} + {V}_{2} ) / {V}_{2} - {P}_{1} \times {V}_{1} / {V}_{2} \qquad ( 2 )$$

The porosity P₂ of the sealing portion is measured at any 20 points on each end surface, and the average value is taken as the average porosity of the sealing portions on each end surface.

In addition, in a test piece of the partition wall portions including the sealing portions, assuming the volume ratio of the volume V₁ including the pores of the partition wall portions is v₁ and the volume ratio of the volume V₂ including the pores of the sealing portions is v₂, P₂ may be calculated by Formula (3).

$${P}_{2} = P \times ( {v}_{1} + {v}_{2} ) / {v}_{2} - {P}_{1} \times {v}_{1} / {v}_{2} \qquad ( 3 )$$

When the honeycomb structure is used as a catalyst carrier, the surface of the partition walls can be coated with a catalyst according to the purpose. As to the catalyst, although not limited, mention can be made to a diesel oxidation catalyst (DOC) for oxidizing and burning hydrocarbons (HC) and carbon monoxide (CO) to increase exhaust gas temperature, a PM combustion catalyst that assists in the combustion of PM such as soot, an SCR catalyst and an NSR catalyst that remove nitrogen oxides (NOx), as well as a three-way catalyst that can simultaneously remove hydrocarbons (HC), carbon monoxide (CO), and nitrogen oxides (NOx). The catalyst may contain as appropriate, for example, noble metals (Pt, Pd, Rh, and the like), alkali metals (Li, Na, K, Cs, and the like), alkaline earth metals (Mg, Ca, Ba, Sr, and the like.), rare earths (Ce, Sm, Gd, Nd, Y, La, Pr, and the like), transition metals (Mn, Fe, Co, Ni, Cu, Zn, Sc, Ti, Zr, V, Cr, and the like), and the like.

### (2. Manufacturing Method)

A honeycomb structure having sealing portions can be manufactured by a known manufacturing method except for the method of forming the sealing portions, and an example of the manufacturing method will be described as below. First, a raw material composition containing a ceramic raw material, a dispersion medium, a pore-forming material, and a binder are kneaded to form a green body, and then the green body is extrusion molded to form a desired honeycomb formed body. Additives such as a dispersant can be mixed into the raw material composition as necessary. In the extrusion molding, a die having a desired overall shape, cell shape, partition wall thickness, cell density, and the like can be used.

The ceramic raw material is a raw material of the portion that remains after firing and constitutes the skeleton of the honeycomb fired body as ceramic, such as metal oxides, metals, or the like. The ceramic raw material may be provided, for example, in the form of powder. As the ceramic raw materials, mention can be made to raw materials for obtaining ceramic, such as cordierite, mullite, zircon, aluminum titanate, silicon carbide, silicon-silicon carbide composite material, silicon nitride, zirconia, spinel, indialite, sapphirine, corundum, and titania. Specific examples include, but are not limited to, silica, talc, alumina, kaolin, serpentine, pyroferrite, brucite, boehmite, mullite, magnesite, aluminum hydroxide, and the like. As the ceramic raw material, one type may be used alone, or two or more types may be used in combination.

In the case of filter applications such as DPF and GPF, cordierite can be suitably used as the ceramic. In this case, a cordierite-forming raw material can be used as the ceramic raw material. The cordierite-forming raw material is a raw material that becomes cordierite when fired. It is desirable that the cordierite-forming raw material have a chemical composition of alumina (Al₂O₃) (including aluminum hydroxide that converts to alumina): 30 to 45% by mass, magnesia (MgO): 11 to 17% by mass, and silica (SiO₂): 42 to 57% by mass.

The pore-forming material is not particularly limited as long as it becomes pores after firing, and examples thereof include wheat flour, starch, foamed resin, water-absorbent resin, silica gel, carbon (for example, graphite), ceramic balloon, polyethylene, polystyrene, polypropylene, nylon, polyester, acrylic resin, phenol, and the like. As the pore-forming material, one type may be used alone, or two or more types may be used in combination. From the viewpoint of increasing the porosity of the honeycomb structure after firing, the content of the pore-forming material is preferably 0.5 parts by mass or more, more preferably 2 parts by mass or more, and even more preferably 3 parts by mass or more, with respect to 100 parts by mass of the ceramic raw material. From the viewpoint of ensuring the strength of the honeycomb structure after firing, the content of the pore-forming material is preferably 30 parts by mass or less, more preferably 27 parts by mass or less, and even more preferably 24 parts by mass or less, with respect to 100 parts by mass of the ceramic raw material.

As the binder, examples include organic binders such as methyl cellulose, hydroxypropoxyl methyl cellulose, hydroxypropyl methyl cellulose, hydroxyethyl cellulose, carboxymethyl cellulose, and polyvinyl alcohol. In addition, from the viewpoint of increasing the strength of the honeycomb formed body, the content of the binder is preferably 4 parts by mass or more, more preferably 5 parts by mass or more, and even more preferably 6 parts by mass or more with respect to 100 parts by mass of the ceramic raw material. From the viewpoint of suppressing cracks due to abnormal heat generation during the firing process, the content of the binder is preferably 9 parts by mass or less, more preferably 8 parts by mass or less, and even more preferably 7 parts by mass or less, with respect to 100 parts by mass of the ceramic raw material. As the binder, one type may be used alone, and two or more types may be used in combination.

As the dispersant, ethylene glycol, dextrin, fatty acid soap, polyether polyol, and the like can be used. As the dispersant, one type may be used alone, or two or more types may be used in combination. The content of the dispersant in the green body is preferably 0 to 2 parts by mass with respect to 100 parts by mass of the ceramic raw material.

The dispersion medium may be water or a mixed solvent of water and an organic solvent such as alcohol, and water is particularly preferred.

The water content of the honeycomb formed body before the drying process is preferably 20 to 90 parts by mass, more preferably 60 to 85 parts by mass, and even more preferably 70 to 80 parts by mass, with respect to 100 parts by mass of the ceramic raw material. When the water content of the honeycomb formed body is 20 parts by mass or more with respect to 100 parts by mass of the ceramic raw material, the quality of the honeycomb structure is likely to be stable, which is an advantage. When the water content in the honeycomb formed body is 90 parts by mass or less with respect to 100 parts by mass of the ceramic raw material, the amount of shrinkage during drying is small, and deformation can be suppressed. As used herein, the water content of the honeycomb formed body refers to a value measured by a loss on drying method.

For drying of honeycomb formed body, conventionally known drying methods such as hot gas drying, microwave drying, dielectric drying, reduced pressure drying, vacuum drying, and freeze drying can be used. Among these, a drying method that combines hot gas drying with microwave drying or dielectric drying is preferable since the entire honeycomb formed body can be dried quickly and uniformly.

The subsequent steps differ depending on whether the honeycomb structure as the product has fired sealing portions or has unfired sealing portions, and will be described separately for each case.

(1) in the Case where the Honeycomb Structure has Fired Sealing Portions

A case where the honeycomb structure has fired sealing portions will be described as below. After drying the honeycomb formed body, unfired sealing portions are formed on both end surfaces of the honeycomb formed body. The unfired sealing portions can be formed by filling the openings of the first and second cells where the sealing portions are to be formed with a sealing portion forming slurry, and then drying the slurry. Next, the unfired sealing portions are fired together with the honeycomb formed body. In this way, fired sealing portions are formed.

In one embodiment, the sealing portion forming slurry contains a cordierite-forming raw material, a dispersion medium, a pore-forming material, and a binder. For example, the sealing portion forming slurry contains 30 to 60 parts by mass of a dispersion medium, 5 to 20 parts by mass of a pore-forming material, and 0.2 to 2.0 parts by mass of a binder, with respect to 100 parts by mass of a cordierite-forming raw material. In a preferred embodiment, the sealing portion forming slurry contains 35 to 50 parts by mass of a dispersion medium, 8 to 16 parts by mass of a pore-forming material, and 0.2 to 1.5 parts by mass of a binder, with respect to 100 parts by mass of a cordierite-forming raw material.

Examples of cordierite-forming raw materials used in the sealing portion forming slurry include silica, talc, alumina, kaolin, serpentine, pyroferrite, brucite, boehmite, mullite, magnesite, and aluminum hydroxide. The blending ratio of these raw materials is selected such that the sealing portion obtained after firing has the above-mentioned chemical composition.

The cordierite-forming raw material is preferably as fine as possible from the viewpoint of improving the smoothness of the outer surface of the sealing portions. For example, the median diameter (D50) in the cumulative particle size distribution on a volume basis determined by a laser diffraction/scattering method is preferably talc: 9 to 31 μm, alumina (and aluminum hydroxide): 3 to 8 μm, kaolin: 2 to 9 μm, and silica: 2 to 8 μm.

The dispersion medium may be water or a mixed solvent of water and an organic solvent such as alcohol, and water is particularly preferred.

The pore-forming material is not particularly limited as long as it becomes pores after firing, and examples thereof include wheat flour, starch, foamed resin, water-absorbent resin, silica gel, carbon (for example, graphite), ceramic balloon, polyethylene, polystyrene, polypropylene, nylon, polyester, acrylic resin, phenol, and the like. As the pore-forming material, one type may be used alone, or two or more types may be used in combination. The median diameter (D50) in the cumulative particle size distribution on a volume basis determined by a laser diffraction/scattering method of the pore-forming material is preferably 35 to 55 μm.

As the binder, examples include organic binders such as methyl cellulose, hydroxypropoxyl methyl cellulose, hydroxypropyl methyl cellulose, hydroxyethyl cellulose, hydroxyethyl methyl cellulose, carboxymethyl cellulose, and polyvinyl alcohol. As the binder, one type may be used alone, or two or more types may be used in combination.

The sealing portion forming slurry may contain a thickener as appropriate. For example, the thickener may be contained in an amount of 0.1 to 0.5 parts by mass, preferably 0.2 to 0.4 parts by mass, with respect to 100 parts by mass of the cordierite forming raw material. Examples of the thickener used in the sealing portion forming slurry include pectin, guar gum, xanthan gum, propylene glycol, and polyethylene oxide. Among these, polyethylene oxide is preferred because the solution exhibits high viscosity even at a low concentration and has a flowability modifying effect. The thickener may be used alone or in combination of two or more kinds.

The sealing portion forming slurry may contain a dispersant as appropriate. For example, the dispersant may be contained in an amount of 0.1 to 3 parts by mass, preferably 0.2 to 2 parts by mass, with respect to 100 parts by mass of the cordierite-forming raw material. Examples of the dispersant include ethylene glycol, dextrin, fatty acid soap, polyalcohol, etc. As the dispersant, one type may be used alone, or two or more types may be used in combination.

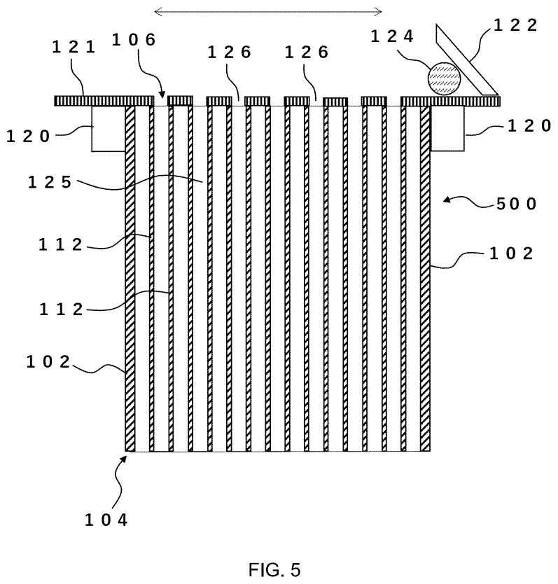

The openings of the cells can be filled with the sealing portion forming slurry by, for example, the following “squeegee method.” As shown in FIG. 5, a film 121 is attached to the upper end surface (here, the second end surface 106 in the figure) of the dried honeycomb formed body 500 fixed by a chuck 120, and a laser is irradiated onto the film 121 at positions corresponding to the arrangement conditions of the sealing portions (for example, “checkered pattern”), thereby drilling a plurality of holes 126 in the film 121.

Thereafter, a sealing portion forming slurry 124 is placed on the film 121, and a squeegee 122 is moved along the film 121 in the direction of the arrow in FIG. 5. As a result, a certain amount of sealing portion forming slurry 124 is filled into cells 125 having openings at positions corresponding to the holes 126 of the film 121.

The depth of the sealing portion can be changed by the number of times the squeegee 122 is moved, the contact angle between the squeegee 122 and the film 121, the pressing pressure of the squeegee 122 against the film 121, and the viscosity of the sealing portion forming slurry 124, and the like.

After filling with the sealing portion forming slurry 124, excess sealing portion forming slurry 124 remaining on the surface of the film 121 is wiped off with a squeegee 122, the film 121 is peeled off, and the entire honeycomb formed body 500 is dried. As a result, the sealing portion forming slurry 124 filled in the cells 125 is dried, and the sealing portions before firing are formed. The drying can be carried out, for example, at a drying temperature of 100 to 230° C. for about 60 to 150 seconds.

The material of the film is not particularly limited, but is preferably polypropylene (PP), polyethylene terephthalate (PET), polyimide, or Teflon (registered trademark), since these materials are easily heat-processed to form holes. The film preferably has an adhesive layer, and the material of the adhesive layer is preferably an acrylic-based resin, a rubber-based material (for example, a rubber whose main component is natural rubber or synthetic rubber), or a silicone-based resin. The film may be, for example, an adhesive film having a thickness of 20 to 50 μm.

Besides the above-mentioned “squeegee method”, another method for filling the openings of the cells with the sealing portion forming slurry is the “press-in method.” The “press-in method” is a method in which an end surface of a honeycomb formed body with a film attached and holes drilled therein is immersed in a liquid tank containing a sealing portion forming slurry, and the cells are filled with the sealing portion forming slurry. In this case, the depth of the sealing portions can be changed by changing the depth to which the honeycomb formed body is immersed in the sealing portion forming slurry.

After drying, the sealing portions protrude from the end surface of the honeycomb formed body by the thickness of the film, and therefore it is preferable to scrape them off and smooth them (hereinafter, also referred to as “smoothing process”). At this time, if the sealing portions have a suitable composition, the outer surface of the sealing portions is easily made smooth. The method of smoothing process is not limited, but a preferred method is to press and rub one end surface of a fired ceramic honeycomb structure (hereinafter also referred to as a “smoothing jig”) against the outer surface of the sealing portions to be smoothed. The smoothing jig may be made of the same material as that of the fired honeycomb formed body to be smoothed, for example, cordierite. However, the smoothing jig may or may not have sealing portions.

The end surface of the smoothing jig is preferably smooth. Specifically, the arithmetic mean height Sa of the partition wall surface constituting the end surface of the smoothing jig is, for example, preferably 1.0 to 5.0 μm, more preferably 2.0 to 4.0 μm, and even more preferably 2.5 to 3.5 μm. The arithmetic mean height Sa of the partition wall surface constituting the end surface of the smoothing jig can be measured using the same method as the method for measuring the arithmetic mean height Sa of the sealing portions described above.

In addition, during smoothing processing, it is preferable to move the smoothing jig and the honeycomb formed body to be smoothed relative to each other such that the directions of the sides (partition walls) that define the opening shape of the cells of the honeycomb formed body to be smoothed and the directions of the sides (partition walls) that define the opening shape of the cells of the smoothing jig are not parallel to each other, for example, such that the angle between the two sides is 30° to 60°. This is because chipping is more likely to occur if the direction of the sides (partition walls) that define the cell opening shape of the honeycomb formed body to be smoothed is parallel to the direction of the sides (partition walls) that define the cell opening shape of the smoothing jig.

The honeycomb formed body filled with the sealing portion forming slurry is then subjected to a degreasing process and a firing process. As a result, a honeycomb structure having fired sealing portions is manufactured. The combustion temperature of the binder is about 200° C., and the combustion temperature of the pore-forming material is about 300 to 1000° C. Therefore, the degreasing step may be carried out by heating the honeycomb formed body to a temperature in the range of about 200 to 1000° C. The heating time is not particularly limited, but is usually about 10 to 100 hours. The honeycomb formed body after the degreasing step is called a calcined body. The firing step may vary depending on the material composition of the honeycomb structure, but may be performed, for example, by heating the calcined body to 1300 to 1450° C. and holding it for 3 to 24 hours.

(2) in the Case where the Honeycomb Structure has Unfired Sealing Portions

Next, a case where the honeycomb structure has unfired sealing portions will be described. In this case, after drying the honeycomb formed body, the degreasing step and the firing step are performed without forming the sealing portions. The conditions for the degreasing step and the firing step are as described above. This results in the manufacture of a honeycomb structure without sealing portions. Next, unfired sealing portions are formed on both end surfaces of the honeycomb structure. The unfired sealing portions can be formed by filling the openings of the first and second cells where the sealing portions are to be formed with a sealing portion forming slurry, and then drying the slurry.

In one embodiment, the sealing portion forming slurry contains cordierite particles, a dispersion medium, and an inorganic binder. For example, the sealing portion forming slurry contains 10 to 35 parts by mass of a dispersion medium and 10 to 25 parts by mass of an inorganic binder with respect to 100 parts by mass of cordierite particles. In a preferred embodiment, the sealing portion forming slurry contains 15 to 30 parts by mass of a dispersion medium and 11 to 20 parts by mass of an inorganic binder with respect to 100 parts by mass of cordierite particles. The blending ratio of these raw materials is selected such that the sealing portions obtained after drying have the above-mentioned chemical composition.

The cordierite particles contain cordierite as a main component. This means that the total mass ratio of cordierite (2MgO·2Al₂O₃·5SiO₂) is 50% by mass or more with respect to 100% by mass of the cordierite particles. The mass ratio of cordierite with respect to 100% by mass of the cordierite particles is preferably 70% by mass or more, and more preferably 80% by mass or more. The method for measuring the cordierite content is as described above.

The cordierite particles are preferably fine from the viewpoint of improving the smoothness of the outer surface of the sealing portions. However, if the cordierite particles are too fine, the porosity decreases. Therefore, it is preferable that the cordierite particles be not too fine so as to obtain the desired porosity. The cordierite particles preferably have a median diameter (D50) of 40 μm or less, more preferably 30 μm or less, in a volume-based cumulative particle size distribution determined by a laser diffraction/scattering method, for example. There is no particular lower limit set for the median diameter (D50) of the cordierite particles. From the viewpoint of availability, the median diameter (D50) of the cordierite particles is usually 10 μm or more, typically 20 μm or more. Therefore, the median diameter (D50) of the cordierite particles is preferably, for example, 10 to 40 μm, and more preferably 20 to 30 μm.

The dispersion medium may be water or a mixed solvent of water and an organic solvent such as alcohol, and water is particularly preferred.

As the inorganic binder, colloidal silica can be suitably used.

The sealing portion forming slurry may contain an organic binder in addition to the inorganic binder. For example, the content may be 0.2 to 2.0 parts by mass, and preferably 0.2 to 1.5 parts by mass, with respect to 100 parts by mass of cordierite particles. As the organic binder, examples include methyl cellulose, hydroxypropoxyl methyl cellulose, hydroxypropyl methyl cellulose, hydroxyethyl cellulose, hydroxyethyl methyl cellulose, carboxymethyl cellulose, polyvinyl alcohol, diutan gum, welan gum, xanthan gum, and guar gum. As the organic binder, one type may be used alone, or two or more types may be used in combination.

The sealing portion forming slurry may contain a dispersant as appropriate. For example, the dispersant may be contained in an amount of 0.1 to 3 parts by mass, preferably 0.2 to 2 parts by mass, with respect to 100 parts by mass of cordierite particles. Examples of the dispersant include ethylene glycol, dextrin, fatty acid soap, polyalcohol, and the like. The dispersant may be used alone or in combination of two or more kinds.

The sealing portion forming slurry can be filled into the openings of the cells by a known filling method such as the above-mentioned “squeegee method” or “press-in method”. The subsequent film peeling and drying conditions are also as described above.

After drying, it is preferable to carry out the smoothing process as described above. At this time, if the sealing portion has a suitable composition, the outer surface of the sealing portion is easily smoothed. The conditions for the smoothing process are as described above.

### EXAMPLES

### Comparative Examples 1 and 2, Example 1

### (1) Preparation of Honeycomb Formed Body

A raw material composition obtained by adding 25 parts by mass of a pore-forming material, 80 parts by mass of a dispersion medium, 5 parts by mass of a binder, and 1 part by mass of a dispersant to 100 parts by mass of the cordierite-forming raw material was kneaded to prepare a green body. The cordierite-forming raw material used was talc, alumina, aluminum hydroxide, kaolin, and silica. Water was used as the dispersion medium, water-absorbent resin and silica gel were used as the pore-forming material, methylcellulose was used as the binder, and ethylene glycol was used as the dispersant.

The green body was put into an extrusion molding machine and extruded through a die of a predesigned shape to obtain a cylindrical honeycomb formed body. The obtained honeycomb formed body was subjected to dielectric drying and hot gas drying, and then both end surfaces were cut to a predetermined dimension, and further dried with hot gas at 70° C. for 2 hours.

### (2) Formation of Sealing Portions

A pore-forming material, a dispersion medium, an organic binder, and a dispersant were added at the blending ratio by mass shown in Table 1 to a total of 100 parts by mass of a cordierite-forming raw material containing each raw material at the blending ratio by mass shown in Table 1, and they were kneaded to prepare a sealing portion forming slurry. As the cordierite-forming raw material, talc, alumina, aluminum hydroxide, kaolin, and silica were used. The median diameters (D50) of these raw materials are as shown in Table 1. A foamed resin was used as the pore-forming material, water was used as the dispersion medium, methyl cellulose was used as the organic binder, and ethylene glycol was used as the dispersant. Using the above-mentioned “squeegee method,” the sealing portion forming slurry was filled in both end surfaces such that the first cells and the second cells were alternately arranged adjacent to each other. After that, the excess sealing portion forming slurry attached to the film was wiped off with a squeegee, and the film was peeled off and dried under the conditions of 180° C.×200 seconds in the air atmosphere.

For each honeycomb formed body, the state of the outer surface of the sealing portions immediately after peeling off the film was observed with an optical microscope (magnification: 100 times), and the peeling depth at five randomly selected peeled portions was measured with a scale, and the peeling of the sealing portions was evaluated according to the following criteria. The results are shown in Table 1.
Circle: ≤1.0 mm
Triangle: 1.1˜1.5 mm
Cross: ≥1.6 mm

### (3) Smoothing Process

A honeycomb structure made of fired cordierite was prepared as a smoothing jig. The specifications of this honeycomb structure are as follows.
Overall shape: Cylinder with diameter 118 mm×height 20 mm
Cell shape in a cross section perpendicular to the cell flow path direction: Square
Cell density (number of cells per unit cross-sectional area): 750 cells/square inch (118 cells/cm²)
Average thickness of partition walls: 2.5 mil (64 μm) (nominal value based on the specifications of the die)
Arithmetic mean height Sa of the partition walls composing the end surface of the smoothing jig: 3.3 μm

Next, for each of the dried honeycomb formed bodies, a smoothing process of the sealing portions was manually performed. During the smoothing process, the honeycomb formed body to be smoothed was moved relative to the smoothing jig such that an angle between the sides (partition walls) defining the cell opening shape of the honeycomb formed body to be smoothed and the sides (partition walls) defining the cell opening shape of the smoothing jig was 45°.

### (4) Firing

Next, the honeycomb structure was degreased by heating at about 200° C. in an air atmosphere, and then fired at 1400° C. for 10 hours in the air atmosphere to obtain a cylindrical honeycomb structure having fired sealing portions. A required number of the honeycomb structures to investigate the following properties were prepared.

### (5) Specifications of Honeycomb Structure

The specifications of the honeycomb structure obtained are as follows:
Overall shape: Cylindrical shape with diameter 132 mm×height 152 mm
Cell shape in cross section perpendicular to the cell flow path direction: Square
Cell density (number of cells per unit cross-sectional area): 300 cells/square inch (47 cells/cm²)
Average thickness of partition walls: 8.5 mil (216 μm) (nominal value based on die specifications)
Average porosity of partition walls: 63%
Average depth of sealing portions: 5 mm

The outer peripheral side wall, the partition walls and the sealing portions of the pillar-shaped honeycomb structure were subjected to X-ray analysis measurements in the range of 20=8 to 100° using an X′pert PRO device manufactured by Malvern Panalytical Ltd. using Cu Kα radiation. The cordierite crystal phase ratio was analyzed using the Rietveld analysis program RIETAN and was found to be 75 to 94% by mass.

### (6) Chemical Composition of Sealing Potions

Since it was difficult to take measurement samples from the honeycomb structure, the same sealing portion forming slurry as that used for preparing the sealing portions was prepared, and measurement samples were prepared by the above-mentioned procedure, and the chemical composition was measured by the above-mentioned method. The results are shown in Table 1.

### (7) Median Diameter of Sealing Potions

Since it was difficult to take a measurement sample from the honeycomb structure, the same forming sealing portion forming slurry as that used for preparing the sealing portions was prepared, and measurement samples were prepared by the procedure described above, and the median diameter of the ceramic composing the sealing portions was measured by the method described above. The results are shown in Table 1.

### (8) Arithmetic Mean Height Sa of Sealing Portions

The arithmetic mean height Sa of the sealing portion on one end surface of the obtained honeycomb structure was measured using a shape analysis laser microscope VK X250/260 manufactured by Keyence Corporation in the above-mentioned manner. The results are shown in Table 1. Although the arithmetic mean height Sa of the sealing portions on the other end surface is not shown in Table 1, it was approximately the same as that of the one end surface.

### (9) Average Porosity of Sealing Portions

The average porosity of the sealing portions on one end surface of the obtained honeycomb structure was measured by the method described above. The results are shown in Table 1. Although the average porosity of the sealing portions on the other end surface is not shown in Table 1, it was approximately the same as that of the one end surface.

### (10) Strength of Sealing Portions

Nine sealing portions (one was taken at the center of gravity of the end surface, and with the center of gravity as the origin O of an XY coordinate system, two were taken equally spaced in the ±direction of the X axis and the other two were also taken equally spaced in the ±direction of the Y axis) excluding those located within 5 mm from the outer periphery on one end surface of the obtained honeycomb structure were pushed with a stainless steel push rod (cylindrical shape with diameter 1.1 mm×length 40 mm) inserted from the other end surface side, and the applied force was gradually increased. As the applied force increased, the push rod eventually penetrated the sealing portion. As the applied force increased, the push rod eventually penetrated the sealing portion. The maximum load (strength of the sealing portion) until the penetration was achieved was measured with a load cell. The sealing portions of the other end surface were also subjected to measurement in the same manner. In this manner, the strength of a total of 18 sealing portions were measured for one honeycomb structure, and the average value was calculated. The relative values, with the average value of Comparative Example 1 taken as 1.0, are shown in Table 1.

### Examples 2 to 4

(1) Preparation of Cylindrical Honeycomb Structure without Sealing Portions

A cylindrical honeycomb formed body was produced under the same conditions as in Example 1. Thereafter, the obtained honeycomb formed body was subjected to dielectric drying and hot gas drying, and then both end surfaces were cut to a predetermined dimension, and further subjected to hot gas drying under the conditions of 70° C.×2 hours. Next, the honeycomb structure was degreased by heating at about 200° C. in the air atmosphere, and further fired at 1400° C. for 10 hours in the air atmosphere to obtain a cylindrical honeycomb structure without sealing portions.

### (2) Formation of Sealing Portions

A dispersion medium, an organic binder, colloidal silica (inorganic binder), and a dispersant were added at the blending ratio by mass shown in Table 1 to a total of 100 parts by mass of cordierite particles A (cordierite content=90% by mass) and cordierite particles B (cordierite content=90% by mass) blended at the blending ratio by mass shown in Table 1, and they were kneaded to prepare a sealing portion forming slurry. The chemical compositions of cordierite particles A and cordierite particles B were measured by quantitative analysis using fluorescent X-ray analysis. Cordierite particles A contained 53.0% by mass of SiO₂, 32.1% by mass of Al₂O₃, and 11.1% by mass of MgO. The cordierite particles B contained 54.5% by mass of SiO₂, 30.9% by mass of Al₂O₃, and 12.4% by mass of MgO. Their median diameters (D50) are as shown in Table 1. Water was used as the dispersion medium, diutan gum was used as the organic binder, and ethylene glycol was used as the dispersant. Using the above-mentioned “squeegee method,” this sealing portion forming slurry was filled into both end surfaces such that the first cells and the second cells were alternately arranged adjacent to each other. Thereafter, excess sealing portion forming slurry attached to the film was wiped off with a squeegee, and the film was peeled off and dried under the conditions of 180° C.×200 seconds in the air atmosphere.

For each honeycomb structure, peeling of the sealing portions was evaluated in the same manner as in Example 1. The results are shown in Table 1.

### (3) Smoothing Process

A honeycomb structure made of fired cordierite was prepared as the smoothing jig. The specifications of this honeycomb structure were the same as those of the smoothing jig used in Example 1.

Next, for each of the honeycomb structures after the sealing portions were dried, smoothing processing of the sealing portions was manually performed. During the smoothing process, the honeycomb formed body to be smoothed was moved relative to the smoothing jig such that an angle between the sides (partition walls) defining the cell opening shape of the honeycomb formed body to be smoothed and the sides (partition walls) defining the cell opening shape of the smoothing jig was 45°. In this manner, a honeycomb structure having unfired sealing portions was manufactured. A required number of the honeycomb structures to investigate the following properties were prepared.

### (4) Specifications of Honeycomb Structure

The specifications of the honeycomb structure obtained are as follows:
Overall shape: Cylindrical shape with diameter 132 mm×height 152 mm
Cell shape in cross section perpendicular to the cell flow path direction: Square
Cell density (number of cells per unit cross-sectional area): 300 cells/square inch (49 cells/cm²)
Average thickness of partition walls: 8.5 mil (216 μm) (nominal value based on die specifications)
Average depth of sealing portions: 5 mm
Average porosity of partition walls: 63%

The outer peripheral side wall, the partition walls and the sealing portions of the pillar-shaped honeycomb structure were subjected to X-ray analysis measurements in the range of 20=8 to 100° using an X′pert PRO device manufactured by Malvern Panalytical Ltd. using Cu Kα radiation. The cordierite crystal phase ratio was analyzed using the Rietveld analysis program RIETAN and was found to be 75 to 94% by mass.

### (5) Properties of Sealing Portions

The chemical composition, the median diameter, the arithmetic mean height Sa, the average porosity, and the strength of the sealing portions were measured in the same manner as in Example 1. The results are shown in Table 1.

TABLE 1

| | | | Median | | | | | | |
|---|---|---|---|---|---|---|---|---|---|
| | | | diameter | Comparative | Comparative | Example | Example | Example | Example |
| Test No. | | | (μm) | Examlpe 1 | Examlpe 2 | 1 | 2 | 3 | 4 |
| Blenging | Cordierite-forming | Talc | 30 | 40 | 40 | 40 | — | — | — |
| ratio | particles (unfired) | Alumina | 6 | 15 | 15 | 10 | — | — | — |
| by | | Aluminum | 2 | 10 | 10 | 19 | — | — | — |
| mass | | hydroxide | | | | | | | |
| of | | Kaolin | 6 | 25 | 30 | 22 | — | — | — |
| raw | | Silica | 3 | 10 | 5 | 9 | — | — | — |
| materials | | Total | — | 100 | 100 | 100 | — | — | — |
| of | Pore-forming material | | 52 | 21 | 12 | 8 | — | — | — |
| sealing | Dispersion medium | | — | 44 | 41 | 36 | 26 | 23 | 19 |
| portion | Organic binder | | — | 0.45 | 0.45 | 0.45 | 0.20 | 0.20 | 0.20 |
| forming | Dispersant | | — | 1.00 | 0.70 | 0.30 | 0.11 | 0.11 | 0.11 |
| slurry | Cordierite | Cordierite | 37 | — | — | — | 100 | 100 | 60 |
| | particles (fired) | Particles A | | | | | | | |
| | | Cordierite | 14 | — | — | — | — | — | 40 |
| | | Particles B | | | | | | | |
| | Colloidal silica *Blending ratio | | — | — | — | — | 11 | 14 | 18 |
| | calculated as solid content | | | | | | | | |
| Chemical | SiO2 | | | 49.8 | 49 8 | 50.0 | 56.2 | 57.2 | 54 8 |
| composition | Al2O3 | | | 34.5 | 35.0 | 35.2 | 31.6 | 29.8 | 30.5 |
| of sealing | MgO | | | 14.0 | 13.4 | 13.3 | 10.2 | 11.1 | 12.0 |
| potions | | | | | | | | | |
| (% by mass) | | | | | | | | | |

| Median diameter of sealing portion (μm) | | 44.6 | 21.9 | 21.2 | 22.3 | 17.5 | 14.2 |
|---|---|---|---|---|---|---|---|
| Surface roughness (arithmetic mean height) Sa (μm) | | 30.9 | 19.9 | 18.0 | 17.1 | 15.3 | 10.8 |
| Average porosity of sealing portions (%) | | 80 | 72 | 65 | 50 | 45 | 36 |
| Evalution | Amount of peeling of sealing portions (mm) | 1.9 | 1.4 | 1.0 | 0.9 | 0.7 | 0.1 |
| | Peeling of sealing portions | X | Δ | ◯ | ◯ | ◯ | ◯ |
| | Strength of sealing portions | 1.0 | 1.3 | 1.4 | 1.7 | 1.9 | 2.1 |

### DESCRIPTION OF REFERENCE NUMERALS

100: Honeycomb structure
102: Outer peripheral side wall
104: First end surface
106: Second end surface
108: First cell
109: Sealing portion
110: Second cell
112: Partition wall
120: Chuck
121: Film
122: Squeegee
124: Sealing portion forming slurry
125: Cell
126: Hole
500: Honeycomb formed body

1. A honeycomb structure, comprising an outer peripheral side wall; a plurality of first cells arranged on an inner peripheral side of the outer peripheral side wall, extending from a first end surface to a second end surface, having an opening on the first end surface and having a sealing portion on the second end surface; and a plurality of second cells arranged on the inner peripheral side of the outer peripheral side wall, extending from the first end surface to the second end surface, having the sealing portion on the first end surface and having the opening on the second end surface, wherein the first cells and the second cells are arranged adjacent to each other with a partition wall interposed therebetween;
wherein the sealing portion is composed of a ceramic containing MgO: 9.0 to 13.4% by mass, Al₂O₃: 29.0 to 35.5% by mass, and SiO₂: 50.0 to 58.0% by mass, and
wherein an arithmetic average height Sa of the sealing portion on the first end surface and the second end surface is 18.0 μm or less, respectively.

2. The honeycomb structure according to claim 1, wherein the sealing portion is composed of a ceramic containing MgO: 9.0 to 12.0% by mass, Al₂O₃: 29.8 to 32.0% by mass, and SiO₂: 54.0 to 57.2% by mass.

3. The honeycomb structure according to claim 1, wherein the arithmetic mean height Sa of the sealing portion on the first end surface and the second end surface is 5.0 to 17.5 μm, respectively.

4. The honeycomb structure according to claim 1, wherein the arithmetic mean height Sa of the sealing portion on the first end surface and the second end surface is 5.0 to 12.0 μm, respectively.

5. The honeycomb structure according to claim 1, wherein the sealing portion is in an unfired state.

6. The honeycomb structure according to claim 5, wherein the ceramic composing the sealing portion comprises cordierite particles, and colloidal silica bonding the cordierite particles together.

7. The honeycomb structure according to claim 1, wherein the sealing portion is in a fired state.

8. The honeycomb structure according to claim 7, wherein the ceramic composing the sealing portion is a fired body of cordierite.

9. The honeycomb structure according to claim 1, wherein a median diameter of the ceramic composing the sealing portion is 5 to 25 μm.

10. The honeycomb structure according to claim 1, wherein an average porosity of the sealing portion on the first end surface and the second end surface is 30 to 70%, respectively.

11. The honeycomb structure according to claim 1, wherein the partition walls are composed of ceramic comprising cordierite as a main component.

12. The honeycomb structure according to claim 1, wherein an average depth of the sealing portion on the first end surface and the second end surface is 3 to 7 mm, respectively.
